(19) United States
(12) Patent Application Publication
(10) Pub. No.: US 2019/0254424 A1
(43) Pub. Date: Aug. 22, 2019

(54) SHELF STANCHION SUPPORT SYSTEM

(71) Applicant: ATTITURE LLC

(72) Inventor: David F. Rassat, Minneapolis, MN (US)

(21) Appl. No.: 16/280,299

(22) Filed: Feb. 20, 2019

Related U.S. Application Data
(60) Provisional application No. 62/633,961, filed on Feb. 22, 2018.

(51) Int. Cl. A47B 47/00; A47B 96/14; F16B 12/10

(52) U.S. Cl. CPC A47B 47/0091; A47B 96/1416; A47B 96/06; A47B 47/0083; F16B 12/10

(57) ABSTRACT

A shelf stanchion support system, which includes modular components easily assembled without, or minimal, tools to provide support posts for horizontal flat shelf members, such as in tables, racks, desks, étagères, carts and the like articles of furniture.

The components include end caps with threaded studs, cylindrical members of different lengths having threaded openings and/or threaded studs to attach to one another. The threaded openings include upstanding protruding collars and counterbores, where shelf attachment occurs to fit into openings in the shelves and enhance stability and ease of tightening.

### CROSS-REFERENCE TO RELATED APPLICATION

This patent application claims the benefit of U.S. Provisional Patent Application No. 62/633,961, filed on Feb. 22, 2018, which is incorporated herein by reference.

### BACKGROUND OF THE INVENTION

### A. Field of the Invention

This invention relates to a stanchion support system that can be utilized for shelf constructions assembled with vertical support posts and horizontal special flat sheet members, such as in tables, racks, desks, étagères, carts and like articles of furniture. The stanchions are made up of a plurality of components, which can be rapidly and easily assembled with shelves of sheet material, such as metal, plastic or glass, preferably without use of tools, or only a few basic tools.

### B. Prior Art

The prior art is replete with shelving, racks and stands that are assembled with modular, posts or stanchions. Many are complex, difficult to manufacture, often expensive, require specialty and complicated machinery, and then assembly may also be expensive and difficult with many components involved. Examples of U.S. patents issued over the years which have addressed and sought to overcome the foregoing problems and deficiencies include U.S. Pat. No. 3,910,206 (1975); U.S. Pat. No. 4,836,393 (1989); U.S. Pat. No. 5,881,653 (1999); and U.S. Pat. No. 6,123,035 (2000). Typically, most providers of furniture items more simply offer modular stanchions that are tubular or solid cylindrical and use studs, which are threaded fasteners, to allow sections and components to be attached to one another. In order to aid in tightening and achieve horizontal and vertical stability, use of washers may be required.

### SUMMARY OF THE INVENTION

The present invention is designed to overcome or avoid deficiencies of the prior art described above. It is a primary object of the present invention to provide a shelf stanchion system that attains the objectives of simplicity, low cost to manufacture, ease of assembly with no tools required, eliminates need for many small and loose parts, and yet allows for enhanced stability, both vertically and horizontally, and easy structural tightening.

In accordance with the illustrative embodiments demonstrating features and advantages of the present invention, there is provided a modular stanchion system, which provides aesthetic appeal with an assembled shelf structure where each stanchion incorporates at least one cylindrical post between a pair of shelves, the post having an upper end with a threaded opening, an annular upwardly protruding collar surrounding the opening, an end cap with a threaded fastener member to attach a top shelf to the post upper end, the lower end of the post carrying a threaded member that can attach a lower shelf to a cylindrical post also having an upper end with a threaded opening and surrounding annular protruding collar, the lower end of the post having a threaded opening to receive a threaded footer or leveler member or even a caster.

The modular post components can be selectively arranged with different lengths and selected to fit with differing numbers of shelves at the same or differing distances from one another and with the shelves being the same or differing or staggering materials. In the exemplary drawing FIG. 1 embodiment, for example, there is a lower shelf, then a second shelf at a first distance from the lower shelf, and then a top shelf at a smaller distance from the second shelf. Also, the lower and second shelves are made of sheet metal and the top shelf is clear glass or plastic. The top shelf could be art decorated or left clear and the upper surface of the second shelf can be art decorated. It will be appreciated that numerous choices can be provided for shelf materials and appearances, which can be mixed or matched or configured in a variety of appearances.

### BRIEF DESCRIPTION OF THE DRAWING(S)

For the purpose of illustrating the invention, there is shown in the accompanying drawings exemplary forms, which are presently preferred; it being understood that the invention is not intended to be limited to the precise arrangements and instrumentalities shown.

FIG. 1 is a front perspective and exploded view of a shelf stanchion support system for a table with three shelves in accordance with the present invention.

FIG. 2 is a front perspective of the table of FIG. 1 fully assembled.

FIG. 3 is a front perspective view of another table, but with two shelves and fully assembled.

FIG. 4 is a front perspective of another fully assembled table;

FIG. 5 is an enlarged, exploded perspective view of the modular stanchion components.

FIG. 6 is a side perspective view of assembled stanchion components; and

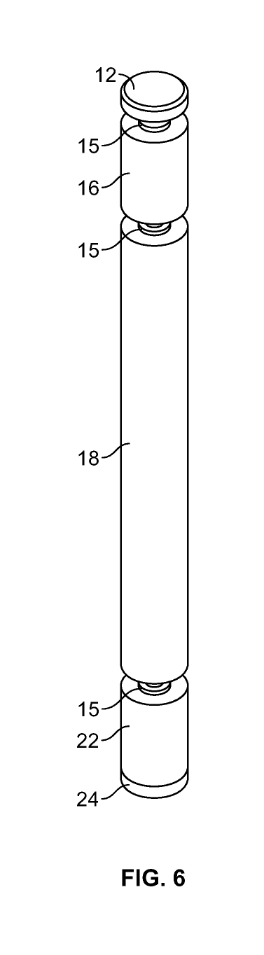

FIG. 7 is a side sectional view of a modular stanchion along the line 7-7 of FIG. 4

### DETAILED DESCRIPTION OF THE INVENTION

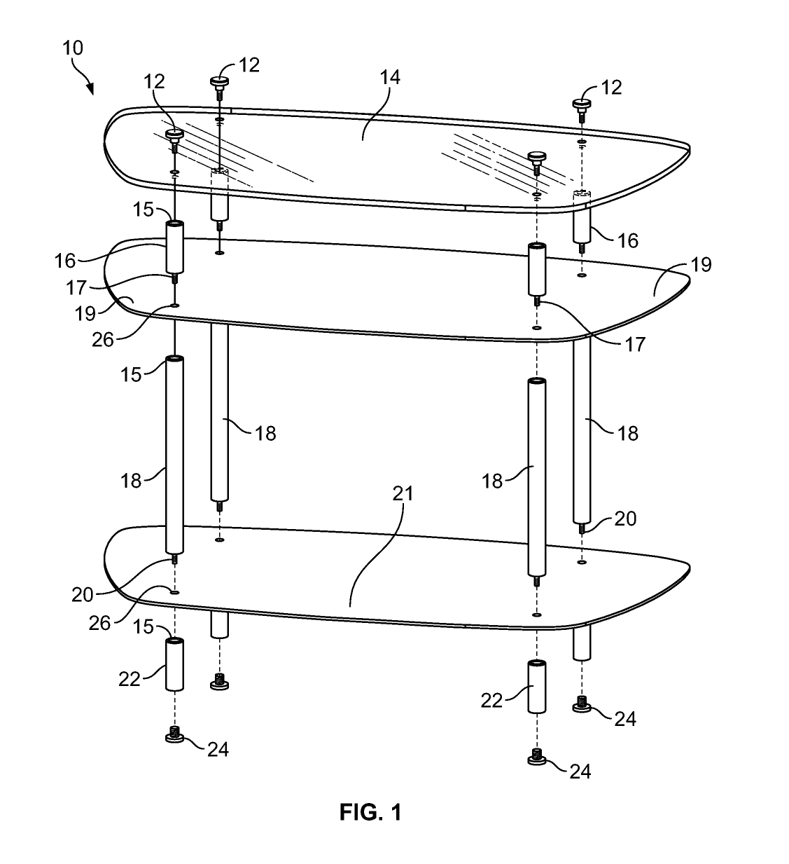

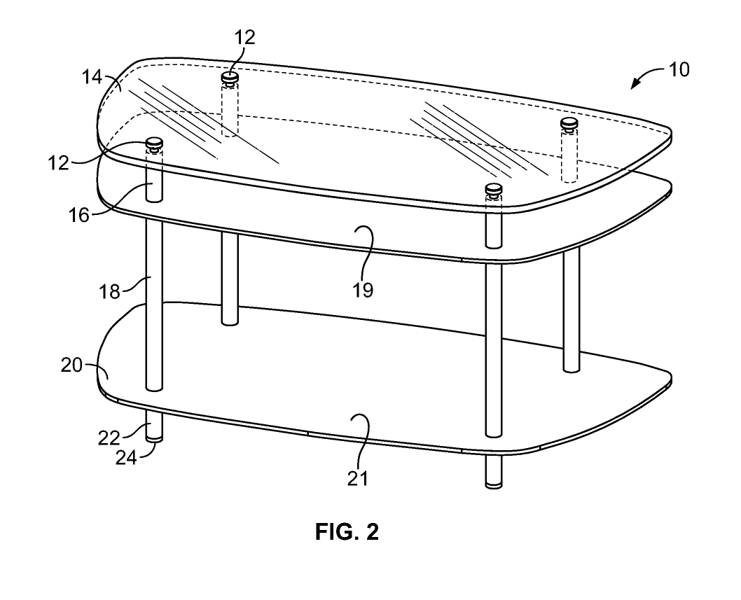

Referring now to the drawings in detail, where reference numerals have been applied and used throughout the various figures to designate like elements, there is shown in FIGS. 1 and 2 a shelf stanchion support system constructed in accordance with the principles of the present invention and designated generally as table 10.

The modular stanchion component system for a table with three shelves, as illustrated in FIG. 1, utilizes a plurality of stanchions, each including from top to bottom, an end cap 12 threadibly attachable to a first cylindrical member 16 to hold a top shelf 14; a second cylindrical member 18 attachable to the threaded stud 17 of the first cylindrical member 16 to hold shelf 19; and a third cylindrical member 22 with a threaded opening 15 attaches to the threaded stud 20 of the second cylindrical member 18 to attach shelf 21.

The third cylindrical member 22 has double sided threaded openings 15 and the lower end receives a threaded foot leveler 24.

It will be appreciated that the third cylindrical member could alternatively be adapted to receive a caster in lieu of a leveler 24 and the shelf structure could then become mobile as with a cart.

Furthermore, in the table structure shown in FIG. 1, the first cylindrical members 16 are shorter in length than the second cylindrical members 18, so that the top shelf 14 is closer to the second shelf 19 and the third shelf 21 is wider spaced from the second shelf 19. The third cylindrical member 22 is also provided in a shorter length so that the third or lowest shelf is closer to the floor or surface supporting the shelf system.

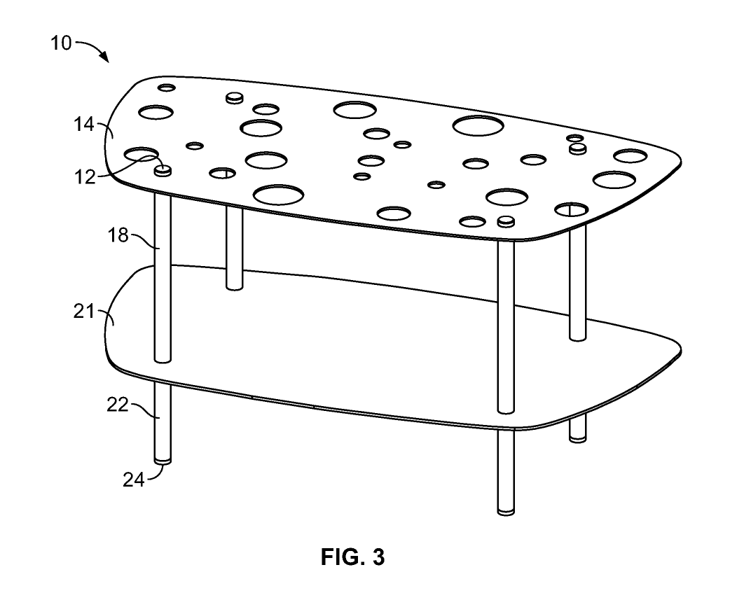

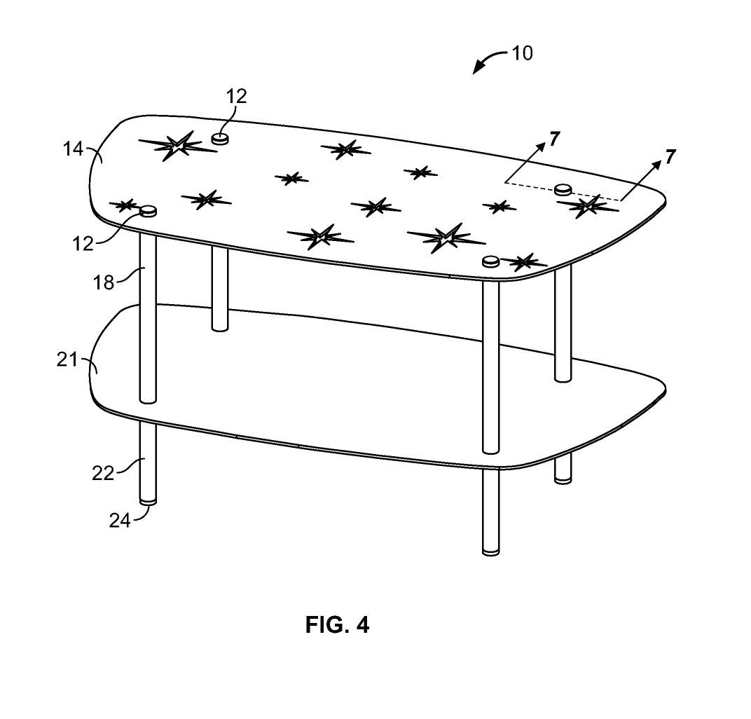

In the illustration of table 10, shown in FIG. 1, the top shelf 14 is preferably clear glass or plastic and the second shelf 19 and third shelf 21 are sheet material, such as metal or plastic. The second shelf 19 can be imprinted with an artistic work or surface design or even a stamped or embossed pattern (as top shelves in FIGS. 3 and 4) viewable through the clear top shelf 14. FIG. 2 illustrates the table of FIG. 1 assembled.

FIGS. 3 and 4 illustrate alternative table configurations with two shelves and metal tops that include stamped designs.

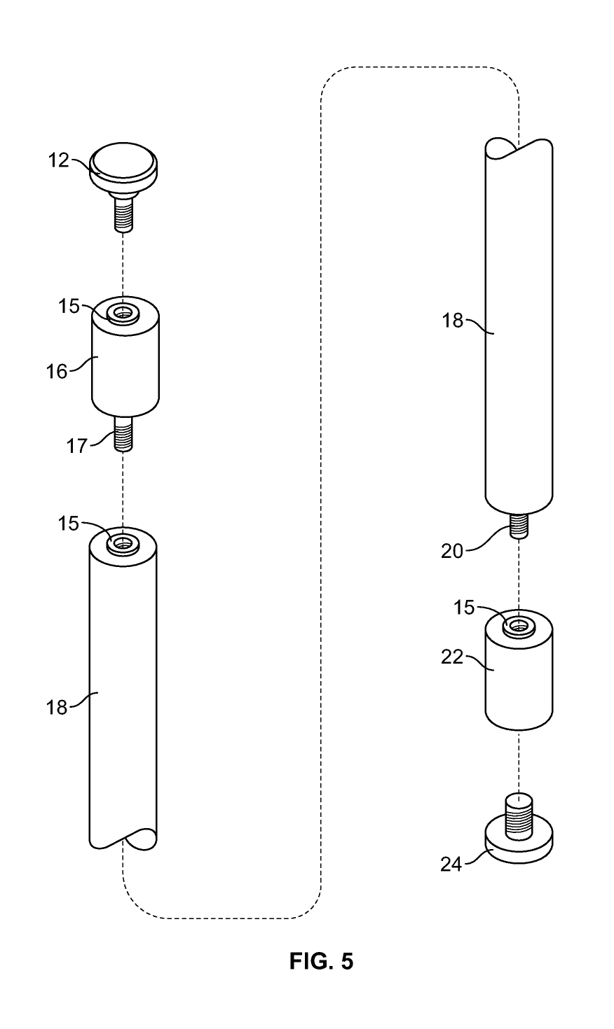

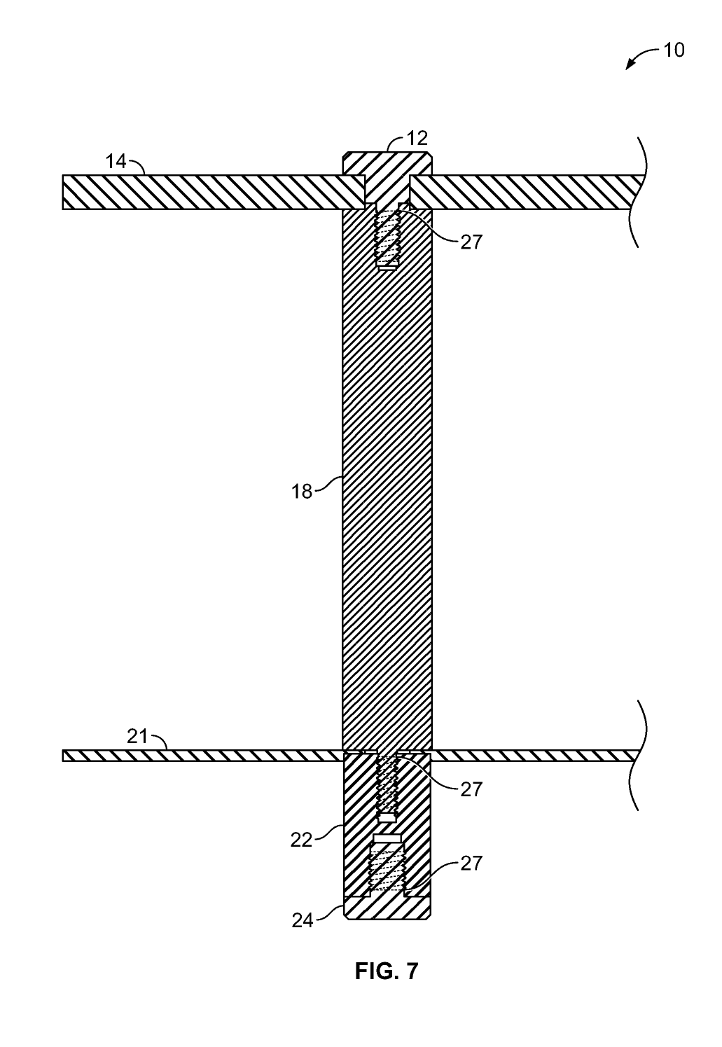

Referring to FIG. 5, there is shown an enlarged exploded view of the modular stanchion components of the FIG. 1 embodiment for a table 10, which includes special features to enhance stability, both vertically and horizontally and provides for tight mounting without need for tools or possibly without need for washers. To this end, the first, second and third cylinder members are provided with upstanding collars 25, surrounding the threaded openings 15 where present on the cylinder members with the outer diameter of the collars made to fit into the opening 26 of shelves 14, 19 and 21. Also, counterbores 27 are provided within the collars on top of the threaded opening 15 as illustrated in sectional view of the cylinder members, FIG. 7.

The counterbores 27 allow for transition fillets on the bolt stud ends 17 and 20 of components such as end caps 12, cylinder members 16, 18 and 22, and levelers 24 for tightening.

It should be noted that the present modular stanchion support system allows mixing or matching multiple same length tubular members between shelves and thereby stacking of shelves for tables, racks, desks, étagères, carts and other like articles of furniture.

The present invention may be modified or changed without departing from the sprit or essentials according to the appending claims.

What is claimed is:

1. A shelf stanchion support system providing a modular vertical post comprising:
a. an end cap having a threaded stud end;
b. a first cylindrical member having a threaded opening at one end to be attached to the end cap with a top shelf therebetween, the shelf having an opening formed therein;
c. said first cylindrical member having an upstanding collar surrounding the threaded opening and adapted to fit within the shelf opening;
d. said first cylindrical member having a threaded stud at its other end;
e. a second shelf member, including an opening for the first cylindrical member threaded stud to pass through; and
f. a second cylindrical member having a threaded opening with upstanding collar fitting into the second shelf opening attachable to the first cylindrical member threaded stud to attach the second shelf to the stanchion.

2. A shelf stanchion support system as claimed in claim 1, wherein said second cylindrical member has a threaded opening at its other end adapted to receive a foot leveler.

3. A shelf stanchion support system as claimed in claim 1, wherein said second cylindrical member has a threaded stud at its lower end to connect with a third cylinder member having a threaded opening and attaching a third shelf there between.

4. A shelf stanchion support system as claimed in claim 1, wherein said cylinder members' threaded openings include counterbores within the collars.

5. A shelf stanchion support system as claimed in claim 1, wherein the first shelf is glass and the second shelf is metal.

6. A shelf stanchion support system as claimed in claim 1, wherein the first shelf includes a stamped pattern therein.

7. A shelf stanchion support system as claimed in claim 3, wherein the third cylinder member has a threaded stud at its other end.

8. A shelf stanchion support system as claimed in claim 3, wherein said third cylinder member has a threaded opening at its other end and receives a leveler foot therein.

9. A shelf stanchion support system as claimed in claim 3, wherein the first and second cylinder members are different lengths.

10. A shelf stanchion support system as claimed in claim 1, wherein the first and second cylinder members are different lengths.

11. A shelf stanchion support system as claimed in claim 3, wherein the third cylindrical member has an opening at its other end for receiving a caster.

12. A shelf stanchion support system as claimed in claim 3, wherein the first, second and third cylinder members are of different lengths from one another.
